(19) United States
(12) Patent Application Publication
(10) Pub. No.: US 2003/0071843 A1
(43) Pub. Date: Apr. 17, 2003

(54) System and method for specifying and applying microarray data preparation

(76) Inventors: Bruce Hoff, Venice, CA (US); Soheil Shams, Redondo Beach, CA (US); Sorin Draghici, Detroit, MI (US); Kiyoko Aoki, Playa del Rey, CA (US)

Correspondence Address: Cary Tope-McKay, 23852 Pacific Coast Highway #311, Malibu, CA, 90265, US

(21) Appl. No.: 09/981,865

(22) Filed: Oct. 17, 2001

(51) Int. Cl. G09G 5/00

(52) U.S. Cl. 345/763; 345/835; 345/769

(57) ABSTRACT

Systems and methods of analyzing data and for specifying and applying user-selected, user-variable sequences of mathematical data preparation operations to data and methods for normalizing data that include dividing the data into a plurality of groups where the number of groups is a function of the range and number of values and for calculating a normalization correction for each group are disclosed.

This invention relates to systems and methods for analyzing data such as microarray data, and, more particularly, for specifying and applying a user-selected, user-variable sequence of mathematical data preparation operations (DPO's) to data. Microarray data is numerical information derived from a microarray experiment. A microarray is a collection of known genetic material such as nucleic acids, proteins, small molecules cells or other substances placed and immobilized on a subtrate such as a glass slide or silica wafer. Such a microarray often appears as a microscopic, ordered array of such substances that enables parallel analysis of complex biochemical samples. A microarray experiment is an experiment done upon a microarray that produces microarray data. The invention includes a device for specifying multiple sources of related data (and their relationships) upon which the DPO's operate and some of the novel operations performed by some DPOs, such as non-linear normalization of unequal channel effects in a multi-channel experiment.

The systems include a computer readable medium comprising one or more DPO's that a user can load, select, sequence and then apply to the input data. These systems preferably include a computing device such as a personal computer or workstation. Upon application of the user-selected, user-sequenced DPO's to the input data, the results can immediately be displayed or stored in numerical terms.

In a preferred embodiment, the computer-readable medium is a hard disc, CD-ROM, or other similar computer-readable medium such a medium being the CD-ROM containing the GeneSight software product from BioDiscovery, Inc. This product includes a computer-executable program comprising a software module, written in Java, with a user interface having a transformation toolbar, a sequence assembly area, and a plurality of user-selectable, user-sequenceable operations such as DPO's.

In a preferred embodiment, the system includes a user interface display, for example, on a cathode-ray tube (CRT), comprising: a toolbar of DPO icons, a sequence assembly area into which a user drags and sequences, in user-selected order, a plurality of such icons, and a customized dialog box for each DPO a user selects. These dialog boxes prompt a user to choose from and enter one or more of the various parameters associated with a particular DPO.

Each DPO includes:

1) An associated icon (a small version displayed in the toolbar and a larger version displayed in the sequence assembly area),

2) Ability to drag a selected icon from the toolbar into a place within a sequence assembly area. Any restrictions regarding the location of where the DPO can be inserted will be enforced when dragged. For example, in some cases, one type of DPO can only be inserted before another type.

3) An associated routine which performs a specific operation on the data at the desired stage in the processing pipeline. The DPO's operate on data one after another, in accordance with the user-selected sequence, each DPO modifying the data in a predefined way.

4) An associated pop-up dialog box to prompt the user for data preparation parameters.

These new systems include a memory that stores input data such as microarray data. Such microarray data may be in tabular form, in preferred embodiments. At a most fundamental level, the data table is a matrix of gene expression values. Each row corresponds to one gene or clone, and each column corresponds to one experimental condition, or vice versa. Therefore, each entry is the expression value of one gene or clone under one experimental condition.

These expression values come from expression data sources. An expression data source is a source of numerical information, such as a file or database. A data source contains quantified microarray data, typically produced by an image analysis software, such as BioDiscovery's ImaGene product.

The process of specifying data sources to use, and how to combine these sources in a preferred embodiment, appears, in a simple, intuitive way, in the “data set builder” module of the GeneSight software package. The “data set builder” is a software tool which groups and organizes the information from one or more data sources for analysis. The operation of the data set builder follows. The data set builder comprises four elements:

1) The data source list: The list of available data sources that may be used in a data set.

2) The experiment/control lists: Two lists of data sources taken from the data source list. These two lists represent data sources that may be combined in pairs. This allows DPO's that perform pairing, such as the ratio and difference DPO's, to be used on this data set.

3) The replicate experiment list: A list of data sources, or pairs of data sources from the experiment/control lists, that represent those that may be combined, such as with the Combine Replicates DPO. This list represents experiments that have been repeated and have produced a number of experimental values for the same condition(s).

4) The final data set: A list of either (1) single data sources, as from the data source list, (2) paired data sources, as from the experiment/control lists, or (3) replicated data sources, as from the replicate experiment list. These data sources provide the experimental values used in this invention.

This data set builder allows the incorporation of data sources that may not have precisely the same gene sets. The user has the option of taking the intersection or union of the gene sets in these types of data sources.

Background correction, if included, is preferably first in the DPO sequence. Other DPO sequences might be more logical than their permutations, but the embodiment of the invention in GeneSight enforces no other constraints. The invention contemplates a general mechanism for specifying such constraints, and can therefore make any DPO force itself to precede any of a list of other types of DPO's, as needed.

The transformation from quantified spot values to gene expression values may involve a number of different sequences of DPO's. A preferred embodiment includes the following exemplary set of possible DPO's:

A) Background correction: Removes ambient background values from quantified spot values. The background value for each gene may come from the same or from a different expression data source. Usually, background correction is performed by subtraction. There are several variations:

a. Local: Subtract from the spot intensity the immediate background around the spot. The “immediate background” is the average or median of the brightness of the image pixels in the immediate vicinity of, but not including, the spot.

b. Subgrid Median: A microarray image is a rectangular array of spots, which may be further segmented into subgrids, each of which is an uninterrupted rectangular array of spots. To apply this method, for each spot first determine the image subgrid containing it. Then take the median of the local background values for all spots within the subgrid, and subtract this median from the spot's signal intensity. This method is robust to contamination of the background intensity of a few spots within a subgrid, but assumes that the background intensity is consistent across the subgrid, so that the median is a good estimate of the background for each spot within the subgrid.

c. Local Group Median: For each spot, this method subtracts the median of the background levels of the n×n square of nearby spots, where n is selectable by the user. This method provides an approach intermediate between the local background correction and the subgrid median background correction, useful in the case that there is isolated background contamination, but the true background intensity varies over the subgrid. Normally the n×n array of spots is truncated at the subgrid boundary.

d. Median of Local Blank Spots: For each spot, from the set of neighboring spots indicated as “blank,” this method subtracts the median of the intensities of the n nearest of such spots. The value ‘n’, is user-specified. This method helps when the spots are close together so that there is not much background intensity information. The emplaced “blank spots” provide surrogate background information.

B) Omit Flagged Spots: Removes those expression values from the table that have been “flagged” as poor values or values of some particular interest. Flags are predefined labels associated with each spot value when the data sources are imported, for example, from the data set builder in GeneSight.

C) Combine Replicates: Combines the quantified spot values for multiple spots representing the same gene or clone under the same experimental condition. The replicated spot values may come from the same or from different expression data sources, or both. Expression values can be combined in a number of different ways. These include taking the median or mean of the values, and optionally omitting outliers. To omit outliers we calculate the standard deviation of each set of replicate values, ask the user to specify an outlier “threshold” in terms of the number of standard deviations from the mean beyond which a value is considered an outlier. Outliers are omitted from subsequent evaluation.

D) Fill in missing values: Supplies values for those that have been removed using another DPO (i.e., Omit Flagged Spots). The values inserted may be (1) user-specified, or (2) determined by the range of other values for the specific clone or for the experimental condition, such as average or median of the clone or condition.

E) Floor: Sets those expression values that are below a specified threshold value to the threshold value.

F) Log transform: Modifies all expression values to be the log of the values. The base of the log and the offset can be specified by the user.

G) Ratio: Combines quantified spot values for two experimental conditions to yield expression values which are “relative”, by computing, for instance, the ratio of experiment divided by control. Typically this operation is used to combine the pairs of measurements for each spot in a single, two channel microarray.

H) Difference: As an alternative to the “Ratio” DPO, this combines quantified spot values for two experimental conditions to yield the difference between the values. This alternative would be employed if the logarithm DPO has already been applied to the data.

I) Omit low expression levels: Removes those values that are below a specified threshold value. This is used to remove from the data set measurements which have very low intensity and hence are not considered trustworthy.

J) Normalization: Modifies the expression values to remove experimental artifacts associated with each experimental condition. The modification depends on the DPO's parameters. For example, it may consist of calculating the mean of each condition's values and dividing each value with a condition by the condition's mean. The following is a list of common normalization procedures:

a. Divide by mean: The mean of all the intensity values for one channel of one microarray is calculated. All values within said channel are then divided by this mean. This corrects for linear scaling effects from one array or channel to the next.

b. Divide by percentile: As in (a) but the mean is replaced by the pth percentile, where p is chosen by the user. P=0.50 is equivalent to the population median.

c. Subtract mean: Instead of dividing by the mean, as in (a), the mean is subtracted. This is useful in the case that the Log transform has been applied, transforming scaling effects into additive effects, since this normalization corrects for additive effects.

d. Subtract Percentile: Instead of subtracting the mean, as in (c), the pth percentile (as specified by the user) is subtracted.

e. Z-Score: This normalization procedure first subtracts the population mean, then divides by the population standard deviation, thus correcting for both additive and scaling effects, and transforming the data into the “number of standard deviations from the population mean.”

f. Linear Regression Normalization: This normalization procedure is applied to two-channel pairs (typically from one microarray), in order to shift and scale the data such that the mean squared distance of the points from the first diagonal is minimized.

In addition to the above approaches, a unique non-linear normalization has been developed and implemented in the GeneSight software program and is part of the present invention. Commonly used normalization methods apply a single normalization factor (such as dividing by the mean or median, calculating the z-score, etc.) to all genes. However, in many instances, the needed normalization factor varies in a non-linear way with the intensity of the fluorescent emissions described below. To normalize such different values, our non-linear normalization method divides the intensity range into bins, or groups of neighboring values, and determines the normalization values separately for each bin in a computationally efficient way.

The parameters for this method include the size of each bin, which can be a user-selected number, a value calculated by the method itself, or a constant. To avoid having too few genes in a given bin, leading to a potentially incorrect normalization value, a more adaptive approach increases bin width to ensure that a predetermined number of genes having intensity values fall within the bin's range. The method also makes sure that the correction applied in adjacent bins does not lead to large discontinuities of the normalized values. This can be done by imposing restrictions on the normalization parameters in adjacent bins, or by partially overlapping the bins.

Consider {x₁,x₂, . . . ,xₙ} the ordered values measured for one channel (e.g. control) and {y₁,y₂, . . . ,yₙ} the corresponding ordered values measured for a second channel (e.g. experiment). The method divides the range of the first channel into n bins. Assume that the j-th bin is defined by the values xⱼ and xⱼ₊₁. Assume that the corresponding measurements of the second channel are yⱼ and yⱼ₊₁. For each bin, the method calculates the center of the x and y values falling in that bin. The center can be defined in several ways using means, medians or other center definitions using one of several distance measures (Euclidian, Mahalanobis, Ward's, squared Euclidian, Chebychev, etc.). Alternatively, the bins can be defined by choosing a center value x_{c}, and by taking the boundaries of the bin as x_{c}−Δx/2 and x_{c}+Δx/2 where Δx is a chosen bin size. The center value x_{c} can take values from {xₘᵢₙ, . . . ,xₘₐₓ} where xₘᵢₙ is the largest xⱼ≦x_{c}−Δx/2 and xₘₐₓ is the smallest xⱼ≧x_{c}+Δx/2.

For each bin defined in one of these ways, assume that the center of the x values in the bin is xᵢ, the center of the y values in yᵢ and the centers of the x values and y values in the neighboring bin are xᵢ₊₁ and yᵢ₊₁, respectively. In a preferred embodiment, for each value yₖ corresponding to a value xₖ, where xᵢ<xₖ≦xᵢ₊₁, we then calculate a normalized value ŷₖ as follows:

$$\hat{y} = \frac{{x}_{i + 1} - {x}_{i}}{{y}_{i + 1} - {y}_{i}} \cdot ( y - {y}_{i} ) + {x}_{i}$$

Other formulae may be applied at this stage in order to compensate for other types of non-linear effects unequal on the different channels. The normalization method does this in such a way that certain global properties such as continuity and differentiability are maintained. Such properties are ensured by posing explicit conditions or by overlapping the bins.

By performing the said normalization on bins, our method is more computationally efficient than prior art inasmuch as it reduces the number of operations necessary.

The foregoing set is only an example of potential DPO's and their specific operations on the data. Many other operations on one or multiple sets of values are also feasible. Since the user might require different sets of the above operations to be applied in different sequences depending on the type of experiment, the present invention offers a simple, intuitive, and very flexible means to accomplish this task. In practice, there are sets of ordered DPO's that are typically used. In one such preferred embodiment, GeneSight, these are:

Simple

Local background correction

Omit flagged spots

Compute ratio

Normalize

or

Local background correction

Omit flagged spots

Normalize

Compute ratio

Log Scale

Local background correction

Omit flagged spots

Floor low values to 20.0

Compute ratio

Take Log (base 2)

Normalize (subtract from each channel its mean)

Log Scale/Replicates

Local background correction

Omit flagged spots

Floor low values to 20.0

Compute ratio

Take Log (base 2)

Normalize (subtract from each channel its mean)

Combine replicate values

The program preferably outputs a table for display of transformed data, showing the effects of the DPO's. DPO's are applied in a sequence. Each DPO takes as input the data e.g. a data table, as modified by previous DPO(s), performs some operation, and places its results in the data table. The contents of the data table, after application of the DPO's, is sensitive to the order in which the DPO's are applied. Thus, the system displays, and allows a user to control, the order in which the DPO's are applied to the data.

The assembly area preferably displays the sequence by arranging the icons for the DPO's, left to right, with rightward arrows connecting them. Preferably, a button near (e.g., below) the sequence assembly area labeled “Apply Data Preparation” is enabled after any change is made to the sequence. When pressed, the DPO's are applied to the data or data table, in order. The system allows a user to control the order, via a “drag and drop” user interface. The user may drag a DPO icon from the toolbar into place in the sequence. The system then inserts the icon appropriately, connecting it to its predecessor and successor DPO's with rightward arrows. The user may rearrange the icons by dragging an icon from its position in the sequence to a new position. When the icon is positioned, the custom parameter dialog appears, prompting the user to select any needed data preparation parameters. Icons may be dragged out of the sequence assembly area, thereby deleting them from the chosen sequence.

The system has the capability to broadcast software “events”, i.e. messages indicating that the data preparation sequence has changed. Both data displays and various derived graphic plots are designed to “listen” for these events, and update their displayed information immediately. Thus, modifications to the DPO sequence by a user are propagated immediately to the derived displays providing useful interaction and feedback regarding the effects of the chosen numerical operations.

The system preferably includes a menu of predefined sequences of DPO's, the ability to save (into a computer file or database) a user-defined sequence of DPO's, and the ability to re-load a user defined sequence.

The methods of this invention comprise the steps of: selecting, sequencing and displaying a plurality of computer operations, in iconic form, in the graphical user interface of a computer processor, where each displayed icon represents and invokes one or more of these operations; applying the resulting sequence of operations to input data that can be modified by these operations; and outputting, for display or storage, the resulting, modified data. The resulting data can be displayed numerically, in table form, or in graphical form. In preferred embodiments, the input data is microarray data, often in tabular form. The resulting, modified input microarray data, or resulting data, can be stored or displayed as numerical, tabular or graphical data.

### BRIEF DESCRIPTION OF THE DRAWINGS

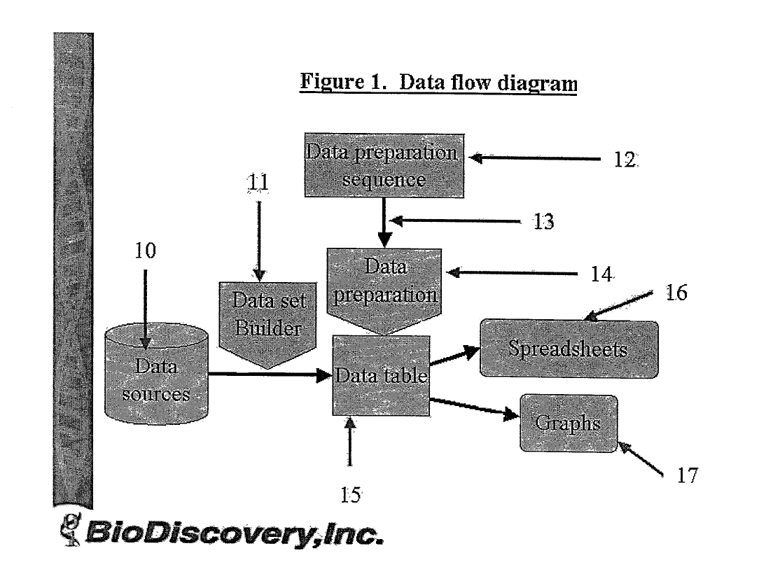

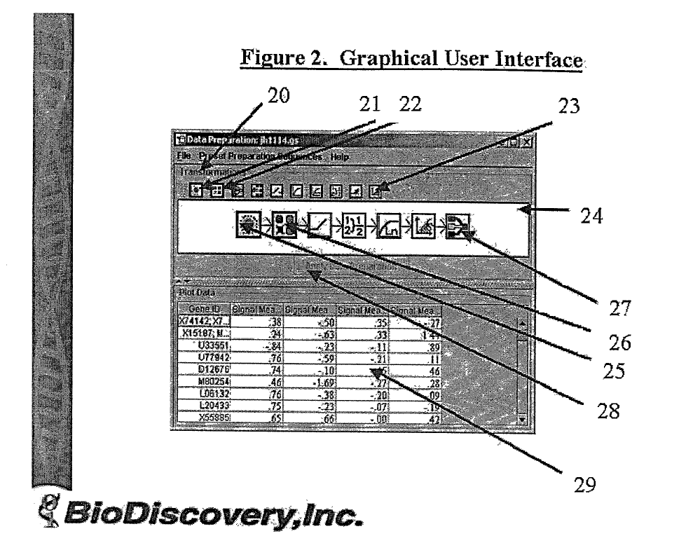

This invention can better be understood by reference to the drawings wherein FIG. 1 illustrates schematically a preferred embodiment of the systems and methods of this invention; and FIG. 2 results obtained using the new normalization methods of this invention.

### DETAILED DESCRIPTION OF THE DRAWINGS

FIG. 1 shows the system for applying a data preparation sequence (12) to a data table (15). The data comes from a set of data sources (10), is organized by a data set builder (11) into the data table (15). The data is transformed by the data preparation module (14). The processed data is then displayed by various spreadsheet views and graphs.

FIG. 2 shows the system for specifying a plurality of data preparation operations 25, 26, . . . 27 in a user-selected, user-sequenced order to a table of raw data. The user selects, from some representation 20 of the available transformations, 21, 22, . . . 23, the data preparation operations he wishes to apply, drags and drops the icons representing the desired operations into assembly area 24, where they are sequenced left-to-right, and connected to one another with rightward-pointing arrows, indicating the sequence in which the operations are to be applied to the table of input data. After assembly and sequencing of the desired DPO's in assembly area 24, the user activates the apply button 28. The processor associated with the system then applies the DPO's displayed in area 24 in the displayed sequence. The resulting data is displayed table 29.

A DPO unique to GeneSight is a non-linear normalization method that is applicable to pairs of measurements, where a “measurement” is a number indicating a level of gene expression as determined by an empirical process. In a microarray, each spot corresponds to a particular gene or clone. Once a microarray slide is processed, or hybridized, two types of molecules will bind to each spot. The two can be thought of as healthy and diseased states of a cell, or as a control and an experimental value, and are differently “labeled.” A label can be a fluorescent dye particle that emits light at a particular wavelength. Examples are the cy3 and cy5 dyes that emit green and red colors, respectively. The system measures the relative intensity of these two emitted colors in two channels, and can plot the level of emission, or expression level, of a gene for each channel on a scatter plot. If a gene is present in the same amount in each state, and therefore in each channel, the levels of emission from each channel are about the same, and the points in a scatter plot of the two channels cluster around a line with slope of 1. If the levels in the two channels differ, the points in the scatter plot lie above or below this line. Due to various causes related to the laboratory procedures and materials, the levels of emission on different channels may be different even if the biological material is the same. Thus, normalizations techniques are necessary in order to compensate for these effects.

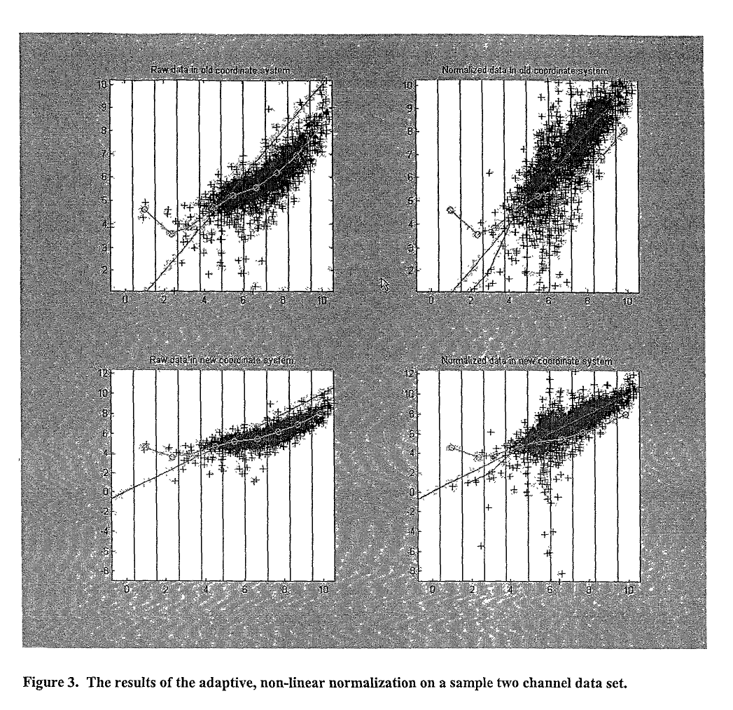

Examplary results of the adaptive, non-linear normalization on some sample two-channel data are presented in FIG. 3. These plots represent the same biological material and should appear along a line with slope 1. The upper left panel shows the raw data which exhibits a displacement from the ideal line of slope 1 (most of the data is below the ideal line) as well as a non-linear distortion (the data is not straight). The upper right panel shows the data after the non-linear normalization was applied on 10 fixed bins. The data is shifted such that it is centered around the ideal line of slope 1 and also straight. The graph in this panel is plotted in the original range of the data for both axes. The lower right panel presents the same normalized data plotted in the ranges resulted after normalization. For comparison, the lower left panel presents the raw data in the same normalized ranges.

Although in this example the non-linear normalization was used to bring the data to a line of slope 1, the same method can be applied to bring the data to any other desired shape as the biological interpretation might require.

Although the present invention has been described with reference to a preferred embodiment, those skilled in the relevant arts will see that many modifications and adaptations of this invention are possible without departure from the spirit and scope of the invention as claimed hereinafter.

What is claimed is:

1. A method of modifying data comprising: loading a computer system including a processor and a display device with a computer-executable program comprising a software module and a user interface having a representation of available transformations, a sequence assembly area, and a plurality of user-selectable, user-sequentiable operations; choosing any number of said operations for application to said data; assembling and optionally displaying the chosen operations in said sequence assembly area; and applying the chosen sequence of operations to said data to produce modified data for storage or display.

2. The method of claim 1 further comprising selecting microarray data as said data.

3. The method of claim 1 or claim 2 wherein each of said operations includes an associated visual representation and performs a specific operation on said data, and wherein each of said operations may include an associated dialog box prompting a user to choose one or more data preparation parameters, and said software module permits a user to drag one or more of said visual representations from said representation of available transformation into said sequence assembly area.

4. The method of claim 1 further comprising selecting said data from microarray data, and arranging said data with a graphical user interface, data set builder, that includes a data source list from which a user can define relationships or associations of the data including pairs of data sources and replicated data sources, as desired.

5. The method of claim 4 further comprising providing said data set builder with the capacity to prepare a data set that includes single data sources, paired data sources, or replicated data sources, at a user's option.

6. The method of claim 1 or claim 2 further comprising choosing said operations from the group consisting of background correction of data values, omission of one or more data item based on a characteristic value, combining replicate data, addition of one or more missing data, modification of data values to raise those below a specified threshold value to the specified threshold value, transforming data, combining replicated data, forming a ratio of two or more data, taking the difference between data, omitting data values based on its value, and normalizing data.

7. The method of claim 6 further comprising choosing said normalizing operation, said normalizing operation including the steps of dividing data values into groups of neighboring values, and determining and applying a specific normalizing factor for each said group.

8. The method of claim 7 further comprising the step of specifying the size of each said group to ensure that a predetermined number of values are in said group

9. A system for modifying data comprising a memory storing said data, a processor for accessing said data from said memory, and optionally a display for displaying said data, said system also including a software module and a user interface having a representation of available transformations, a sequence assembly area, and a plurality of user-selectable, user-sequentiable operations, said software module permitting a user to choose any number of said operations for application of said data, to assemble the chosen operations in said sequence assembly area, and to apply the chosen sequence of operations to said data to produce modified data.

10. The system of claim 9 wherein said data is microarray data.

11. The system of claim 9 or claim 10 wherein each of said operations includes an associated visual representation and performs a specific operation on said data, and wherein each of said operations may include an associated dialog box prompting a user to choose one or more available data preparation parameters, and said software module permits a user to drag one or more of said visual representation from said representation of available transformation into said sequence assembly area.

12. The system of claim 9 further comprising a data set builder module that includes a data source list from which a user can define structures of the date including pairs of data sources and replicated data sources, as desired

13. The system of claim 12 wherein said data set builder has the capacity to prepare a data set from single data sources, from paired data sources, or from replicated data sources, at a user's option.

14. The system of claim 9 or claim 10 wherein said operations are selected from the group consisting of background correction of data, omission of one or more desired data, combining replicate data, addition of one or more missing data at a user's option, modification of data values to raise those below a specified threshold value to the specified threshold value, transforming data to the log of the data, combining replicated data, forming a ratio of two or more data, taking the difference between data, omitting data values below a specified threshold value, and normalizing data.

15. A computer readable medium including a computer-executable program comprising a user interface having a a representation of available transformations, a sequence assembly area, and a plurality of user-selectable, user-sequentiable operations, said medium having stored thereon one or more sequences of instructions for mathematically modifying data, said one or more sequences of instructions causing one or more processors to perform a plurality of acts, said acts comprising: choosing any number of said operations for application to said data; assembling and optionally displaying the chosen operations in said sequence assembly area; and applying the chosen sequence of operations to said data to produce modified data.

16. The computer readable medium of claim 15 wherein each of said operations includes an associated visual representation and performs a specific operation on said data, and wherein each of said operations may include an associated dialog box prompting a user to choose one or more available data preparation parameters, and said software module permits a user to drag one or more of said visual representation from said representation of available transformation into said sequence assembly area.

17. The computer readable medium of claim 15 or claim 16 wherein said operations are selected from the group consisting of background correction of data values, omission of one or more desired data, combining replicate data, addition of one or more missing data at a user's option, modification of data values to raise those below a specified threshold value to the specified threshold value, transforming data to the log of the data, combining replicated data, forming a ratio of two or more data, taking the difference between data, omitting data values below a specified threshold value, and normalizing data.

18. A method for normalizing data comprising the steps of: dividing the data into a plurality of groups, wherein the number of groups is a function of the range and number of values and for calculating a normalization correction for each group.

19. The method of claim 18 wherein the normalized values in said groups are determined such that a particular distribution (such as the scatterplot of the values measured on different channels) is brought to a desired shape.

20. The method of claim 18 or 19 where the groups overlap to such a degree that the computation is efficient in terms of the number of operations executed for a given data set.

21. The method of claim 18, 19 or 20 wherein the desired shape is a line of approximately slope 1.

22. The method of claim 18, 19, 20 or 21 wherein there are no large discontinuities between adjacent groups.
